(19) United States
(12) Patent Application Publication
(10) Pub. No.: US 2016/0200623 A1
(43) Pub. Date: Jul. 14, 2016

(54) GLASS SHEET

(71) Applicant: Asahi Glass Company, Limited, Chiyoda-ku (JP)

(72) Inventors: Nobuaki IKAWA, Tokyo (JP); Ryosuke KATO, Tokyo (JP); Kazuhiko YAMANAKA, Tokyo (JP)

(73) Assignee: Asahi Glass Company, Limited, Chiyoda-ku (JP)

(21) Appl. No.: 15/076,716

(22) Filed: Mar. 22, 2016

Related U.S. Application Data
(63) Continuation of application No. PCT/JP2014/075008, filed on Sep. 22, 2014.

(30) Foreign Application Priority Data
Sep. 25, 2013 (JP) 2013-198469

(51) Int. Cl. C03C 3/087; C03C 3/085; C03C 21/00

(52) U.S. Cl. CPC C03C 3/087; C03C 21/002; C03C 3/085

(57) ABSTRACT

An object of the present invention is to provide a glass sheet in which warpage after chemical strengthening can be effectively suppressed and also polishing treatment or the like before chemical strengthening can be omitted or simplified. Thus, the present invention provides a glass sheet in which a surface Na₂O amount in one surface thereof is lower than the surface Na₂O amount in the other surface by 0.38% by mass to 1.2% by mass.

### TECHNICAL FIELD

The present invention relates to a glass sheet.

### BACKGROUND ART

Recently, in flat panel display devices such as mobile phones or personal digital assistances (PDAs), personal computers, TVs, and car-mounted navigation display devices, a thin sheet-shaped cover glass has been arranged on the front side of a display so as to cover a wider region than an image display area thereof, for protecting the display and for improving the appearance thereof.

Such flat panel display devices are required to be lighter and thinner, and therefore, the cover glass to be used for display protection is also required to be thinned.

However, when the cover glass is thinned, the strength thereof lowers, and the cover glass itself may be broken owing to dropping, etc. in use or carrying thereof. Thus, such a thinned cover glass has a problem in that the primary role of protecting the display devices cannot be fulfilled.

Consequently, in an already-existing cover glass, glass produced by a float process (hereinafter sometimes referred to as float glass) is chemically strengthened to form a compressive stress layer on the surface thereof, thereby enhancing scratch resistance of the cover glass.

It has been reported that float glass is warped after chemical strengthening to lose flatness (Patent Documents 1 to 3). It is said that the warpage may occur resulting from the phenomena that heterogeneity between the glass surface not in contact with a molten metal such as molten tin (hereinafter also referred to as top surface) and the glass surface in contact with the molten metal (hereinafter also referred to as bottom surface) is generated during float forming, whereby a difference in the level of chemical strengthening between the two surfaces is generated.

The warpage of the float glass increases with an increase in the level of chemical strengthening. Accordingly, for responding to the requirement of high scratch resistance, in the case where surface compressive stress is increased more than before, especially to 600 MPa or more, the problem of the warpage becomes more apparent.

Patent Document 1 discloses a glass strengthening method of adjusting the amount of ions that enter glass during chemical strengthening by chemically strengthening the glass after formation of a SiO₂ film on the glass surface. Patent Documents 2 and 3 disclose a method of reducing the warpage after chemical strengthening by controlling the surface compression stress on the top surface side to a specific range.

Heretofore, for reducing the problem of the warpage, there have been taken a coping method of decreasing the strengthening stress produced by chemical strengthening and a coping method of conducting chemical strengthening after a surface heterogeneous layer of glass is removed by subjecting at least one surface thereof to grinding treatment, polishing treatment, or the like.

### BACKGROUND ART DOCUMENT

### Patent Document

Patent Document 1: US 2011/0293928, specification

Patent Document 2: WO 2007/004634

Patent Document 3: JP-A-62-191449

### SUMMARY OF THE INVENTION

### Problems that the Invention is to Solve

However, in the method described in Patent Document 1 in which chemical strengthening is performed after the formation of a SiO₂ film on the glass surface, preheating conditions at chemical strengthening are restricted and further, there is a concern that the film quality of the SiO₂ film would change depending on the conditions to have some influence on the warpage. In addition, in the method in which the surface compressive stress on the top surface side is controlled to a specific range, as described in Patent Documents 2 and 3, there arises a problem from the viewpoint of the strength of glass.

The method of subjecting at least one surface of glass to grinding treatment, polishing treatment, or the like before chemical strengthening is problematic from the viewpoint of improving the productivity, and therefore, it is preferable to omit the grinding treatment, the polishing treatment, or the like.

Furthermore, in the case where the warpage may occur to a certain degree or more after chemical strengthening, at the time of printing a black frame of a cover glass, a gap between the glass and a stage would become too large and therefore, the glass may not be sucked onto the stage. Moreover, in the case where the glass is used as a cover glass integrated with a touch panel, a film of ITO (Indium Tin Oxide) or the like may be formed thereon in a large-sized state in a later step. At that time, there may occur such transport failure that the glass would come into contact with the air knife in a chemical liquid processing tank or in a washing tank, or there may arise such troubles that the warpage may increase during the formation of the ITO film, thus the ITO film-formed state in the substrate peripheral part may not be suitable, and the film would peel off. Furthermore, in the case where there exists a space between an LCD (Liquid Crystal Display) and the cover glass having a touch panel attached thereto, when the cover glass has a certain degree or more of warpage, brightness unevenness or Newton rings may be generated.

Accordingly, an object of the present invention is to provide a glass sheet in which warpage after chemical strengthening can be effectively suppressed and also polishing treatment or the like before chemical strengthening can be omitted or simplified.

### Means for Solving the Problems

The present inventors have found that the occurrence of a difference in the level of chemical strengthening between one surface and the other surface of glass can be suppressed by subjecting a surface of the glass to dealkalization treatment and thus the warpage after chemical strengthening can be reduced. Based on the findings, they have accomplished the present invention.

Namely, the present invention is as shown below.

1. A glass sheet containing 4 mol % or more of Al₂O₃, in which a surface Na₂O amount in one surface thereof is lower than the surface Na₂O amount in the other surface by 0.38% by mass to 1.2% by mass.
2. A glass sheet containing no CaO or containing 6 mol % or less of CaO, in which a surface Na₂O amount in one surface thereof is lower than the surface Na₂O amount in the other surface by 0.38% by mass to 1.2% by mass.
3. A glass sheet containing 3 mol % or more of K₂O, in which a surface Na₂O amount in one surface thereof is lower than the surface Na₂O amount in the other surface by 0.38% by mass to 1.2% by mass.
4. The glass sheet according to any one of items 1 to 3, in which the surface Na₂O amount in one surface thereof is lower than the surface Na₂O amount in the other surface by 0.4% by mass to 0.7% by mass.
5. The glass sheet according to any one of items 1 to 4, which is produced by a float process.
6. The glass sheet according to any one of items 1 to 5, in which the surface having a lower surface Na₂O amount is a surface which has not been in contact with a molten metal in a float bath.
7. The glass sheet according to any one of items 1 to 6, which has a thickness of 1.5 mm or less.
8. The glass sheet according to any one of items 1 to 7, which has a thickness of 0.8 mm or less.
9. A glass sheet obtained by chemically strengthening the glass sheet according to any one of items 1 to 8.
10. A chemically strengthened glass sheet, in which a surface Na₂O amount in one surface thereof is lower than the surface Na₂O amount in the other surface by 0.38% by mass to 1.2% by mass.
11. The chemically strengthened glass sheet according to item 10, which has a thickness of 1.5 mm or less.
12. The chemically strengthened glass sheet according to item 10 or 11, which has a thickness of 0.8 mm or less.
13. A flat panel display device including a cover glass, in which the cover glass is the chemically strengthened glass sheet according to any one of items 10 to 12.

### Advantage of the Invention

The glass sheet of the present invention is subjected to dealkalization treatment on one surface thereof, whereby the occurrence of a difference in the level of chemical strengthening between one surface and the other surface of the glass is suppressed, and the stress produced by chemical strengthening is not decreased. Moreover, even when polishing treatment or the like before chemical strengthening is simplified or omitted, warpage of the glass after chemical strengthening can be reduced and excellent flatness can be obtained.

Moreover, in the case where the glass sheet of the present invention is float glass, according to a preferable embodiment of the present invention, it becomes possible to obtain one in which such recesses that cause troubles to the use as a cover glass are not generated.

### BRIEF DESCRIPTION OF THE DRAWINGS

FIG. 1 is a view schematically showing a double-flow type injector employable in the present invention.

FIG. 2 is a view schematically illustrating a single-flow type injector employable in the present invention.

FIG. 3 is a cross-sectional view of a flat panel display, in which, after a float glass for chemical strengthening of the present invention is chemically strengthened, the float glass is used as a cover glass for the flat panel display.

FIG. 4A shows a schematic explanatory view of a method of supplying a gas containing a molecule having a fluorine atom in the structure thereof with a beam to treat a glass ribbon surface, in the production of a glass sheet by a float process. FIG. 4B is an A-A cross-sectional view of FIG. 4A.

(a) to (d) in FIG. 5 show cross-sectional views of a beam in which the amount of the gas can be adjusted while dividing it into three portions in the width direction of the glass ribbon.

### MODE FOR CARRYING OUT THE INVENTION

### 1. Glass Sheet

In the present invention, the “glass sheet” includes also one obtained by shaping molten glass into a sheet form and, for example, a so-called glass ribbon in a float bath is also a glass sheet. Warpage of the glass sheet after chemical strengthening occurs due to a difference in the level of chemical strengthening between one surface and the other surface of the glass sheet. Specifically, for example, in the case of float glass, the warpage after chemical strengthening occurs due to the difference in the level of chemical strengthening between a glass surface (top surface) which has not been in contact with a molten metal (usually tin) and a glass surface (bottom surface) which has in contact with the molten metal during float forming.

According to the present invention, dealkalization treatment is performed on the glass sheet to control a difference between the degree of dealkalization in one surface and the degree of dealkalization in the other surface to a specific range or more, whereby diffusion rates of ions in one surface and the other surface of the glass sheet can be adjusted and thus the levels of chemical strengthening in one surface and the other surface can be balanced. For this reason, in the glass sheet of the present invention, it is possible to reduce the warpage of the glass sheet after chemical strengthening without adjusting strengthening stress or without conducting grinding treatment, polishing treatment, or the like before chemical strengthening treatment.

In the dealkalization phenomenon of the glass surface, the following three steps (a), (b) and (c) are sequentially repeated in the case where the alkali component is Na. (a) Transportation of the alkali component from inside of the glass to the glass surface (exchange reaction between Na^{|} and H^{|} inside the glass). (b) Exchange reaction between Na⁺ and H⁺ in the glass surface. (c) Removal of Na⁺ that has been exchanged for H⁺, from the glass surface.

The degree of dealkalization in the glass surface can be evaluated by measuring the Na₂O amount therein. In the present invention, the Na₂O amount in the glass is evaluated with XRF (X-ray Fluorescence Spectrometer, X-ray fluorescence spectrometry) using Na—Kα ray.

The analytical conditions in the XRF (X-ray fluorescence spectrometry) method are as mentioned below. The quantitative analysis is carried out according to a calibration curve method using Na₂O standard samples. As the measurement apparatus, there is mentioned ZSX100 manufactured by Rigaku Corporation.

Output: Rh 50 kV-72 mA

Filter: OUT

Attenuator: 1/1

Slit: Std.

Dispersive crystal: RX25

Detector: PC

Peak angle (2θ/deg.): 47.05

Peak measurement time (second): 40

B. G. 1 (2θ/deg.): 43.00

B. G. 1 measurement time (second): 20

B. G. 2 (2θ/deg.): 50.00

B. G. 2 measurement time (second): 20

PHA: 110-450

In the glass sheet of the present invention, the surface Na₂O amount in one surface thereof is lower than the surface Na₂O amount in the other surface by 0.38% by mass to 1.2% by mass, preferably 0.4% by mass to 0.7% by mass. In the glass sheet of the present invention having a surface Na₂O amount within this range, the warpage during chemical strengthening is reduced.

When the surface Na₂O amount in one surface is lower than the surface Na₂O amount in the other surface and a difference therebetween (hereinafter, the difference may be referred to as Δ(Na₂O amount)) is less than 0.38% by mass, the effect of reducing the warpage is small. The Δ(Na₂O amount) is preferably 0.4% by mass or more and more preferably 0.45% by mass or more.

Generally, the glass sheet produced by a float process (hereinafter, sometimes referred to as float glass) warps toward the top surface by approximately 30 μm. Accordingly, when the Δ(Na₂O amount) exceeds 1.2% by mass, there is a concern that an improvement in the warpage becomes excessive and the glass sheet may warp toward an opposite side to a large extent.

Also, in the case where the glass sheet is float glass, when the Δ(Na₂O amount) exceeds 0.7% by mass, the surface of the glass sheet may be likely to have recesses that cause troubles to the use as a cover glass. Accordingly, when the glass surface is required to have no recess, the Δ(Na₂O amount) is preferably 0.7% by mass or less, more preferably 0.65% by mass or less, and particularly preferably 0.6% by mass or less.

The recesses described herein are those which can be recognized as recesses when the surface of the glass sheet is observed by using SEM (scanning electron microscope) at a magnification of 50,000 to 200,000. Typically, the recess has a diameter equal to or more than the range of 10 to 20 nm, and typically has a diameter of 40 nm or less and a depth equal to or more than the range of 5 to 10 nm. The case where recesses are generated to such an extent that the recesses cause troubles to the use as a cover glass means a case where a density of the recesses on the surface is 7 recesses/μm² or more. Accordingly, even though the recesses exist on the surface, the density thereof is preferably 6 recesses/μm² or less. When the density of the recess is 6 recesses/μm², an average distance between the recesses is 460 nm.

In the case of the glass sheet produced by a float process, the surface Na₂O amount in the top surface is preferably lower than the surface Na₂O amount in the other surface, that is, the bottom surface.

In this specification, the one surface and the other surface of the glass sheet indicate one surface and the other surface, respectively, the surfaces being opposite to each other in the thickness direction. Both surfaces of the glass sheet indicate both surfaces which are opposite to each other in the thickness direction.

### 2. Production Method for Glass Sheet

A method of forming a glass sheet having a sheet shape from molten glass in the present invention is not particularly limited, and glass having any composition may be used as long as the glass has a composition capable of being strengthened by chemical strengthening treatment. For example, various raw materials are prepared each in a suitable amount, heated and melted, and then homogenized by defoaming, stirring, or the like, and the resulting one is shaped into a sheet shape by a well-known float process, a down-drawing process (for example, a fusion process or the like), a pressing process, or the like, and after gradually cooled, the sheet is cut into a desired size, followed by subjecting to polishing. Thus, a glass sheet is produced. Of these production methods, in particular, glass produced by the float process is preferable since warpage improvement after chemical strengthening, which is the effect of the present invention, is easily exhibited.

As the glass sheet to be used in the present invention, specifically, for example, glass sheets each formed of soda-lime silicate glass, aluminosilicate glass, borate glass, lithium aluminosilicate glass, or borosilicate glass are typically mentioned.

Of these, glass having a composition containing Al is preferable. When alkali coexists, Al is tetracoordinated, and similarly to Si, participates in forming a network that becomes a skeleton of glass. When tetracoordinated Al increases, the movement of alkali ions is facilitated, and ion exchange easily proceeds during chemical strengthening treatment.

The thickness of the glass sheet is not particularly limited, and for example, there may be mentioned 2 mm, 0.8 mm, 0.73 mm, 0.7 mm, and the like. In order to effectively perform chemical strengthening treatment to be described below, the thickness thereof is usually preferably 5 mm or less, more preferably 3 mm or less, further preferably 1.5 mm or less, and particularly preferably 0.8 mm or less.

Usually, the warpage amount of a glass sheet having a thickness of 0.7 mm after chemical strengthening is required to be 40 μm or less. When CS is 750 MPa and DOL is 40 μm in a glass sheet 90 mm square, the warpage amount after chemical strengthening is about 130 μm. On the other hand, since the warpage amount of a glass sheet after chemical strengthening is inversely proportional to the square of the sheet thickness, the warpage amount when the thickness of the glass sheet is 2.0 mm becomes about 16 μm, and warpage will not substantially become a problem. Accordingly, there is a concern that the problem of warpage after chemical strengthening is likely to occur when the thickness of the glass sheet is less than 2 mm, and typically is 1.5 mm or less.

As the composition of the glass sheet of the present invention, there may be mentioned glass having a composition containing, in terms of mol %, 50 to 80% of SiO₂, 0.1 to 25% of Al₂O₃, 3 to 30% of Li₂O+Na₂O+K₂O, 0 to 25% of MgO, 0 to 25% of CaO, and 0 to 5% of ZrO₂, but is not particularly limited. More specifically, the following glass compositions may be mentioned. Incidentally, for example, the description of “containing 0 to 25% of MgO” means that MgO is not essential and may be contained in an amount of up to 25%. The glass (i) is included in soda-lime silicate glass and the glasses (ii) and (iii) are included in aluminosilicate glass.

(i) Glass having a composition containing, in terms of mol %, 63 to 73% of SiO₂, 0.1 to 5.2% of Al₂O₃, 10 to 16% of Na₂O, 0 to 1.5% of K₂O, 5 to 13% of MgO, and 4 to 10% of CaO.
(ii) Glass having a composition containing, in terms of mol %, 50 to 74% of SiO₂, 1 to 10% of Al₂O₃, 6 to 14% of Na₂O, 3 to 11% of K₂O, 2 to 15% of MgO, 0 to 6% of CaO, and 0 to 5% of ZrO₂, in which a total content of SiO₂ and Al₂O₃ is 75% or less, a total content of Na₂O and K₂O is 12 to 25%, and a total content of MgO and CaO is 7 to 15%.
(iii) Glass having a composition containing, in terms of mol %, 68 to 80% of SiO₂, 4 to 10% of Al₂O₃, 5 to 15% of Na₂O, 0 to 1% of K₂O, 4 to 15% of MgO, and 0 to 1% of ZrO₂.
(iv) Glass having a composition containing, in terms of mol %, 67 to 75% of SiO₂, 0 to 4% of Al₂O₃, 7 to 15% of Na₂O, 1 to 9% of K₂O, 6 to 14% of MgO, and 0 to 1.5% of ZrO₂, in which a total content of SiO₂ and Al₂O₃ is 71 to 75%, a total content of Na₂O and K₂O is 12 to 20%, and when CaO is contained, the content thereof is less than 1%.

In the production method for the glass sheet of the present invention, at least one surface of the glass sheet or glass ribbon is subjected to dealkalization treatment, thereby removing alkaline components, and thus, the surface Na₂O amount in one surface is controlled to be lower than the surface Na₂O amount in the other surface by 0.38% by mass to 1.2% by mass. Hereinafter, the term “glass sheet” may be used as a generic term indicating the glass sheet and the glass ribbon.

As the dealkalization treatment of the glass, examples thereof include a method of forming a diffusion suppressing film containing no alkaline component by using a film-forming method such as a dip coating method and a CVD method; a method of treating the glass with a liquid or gas capable of generating ion exchange reaction with an alkaline component in the glass (JP-T-7-507762); a method of moving ions under an action of an electric field (JP-A-62-230653); and a method of bringing silicate glass containing an alkaline component into contact with water (H₂O) at 120° C. or higher in a liquid state (JP-A-11-171599).

As the liquid or gas capable of generating ion exchange reaction with an alkaline component in the glass, examples thereof include: a gas or liquid containing a molecule having a fluorine atom in the structure thereof; a gas or liquid of sulfur, a compound thereof or a chloride thereof; and a gas or liquid of an acid or a nitride.

As the gas or liquid containing a molecule having a fluorine atom in the structure thereof, examples thereof include hydrogen fluoride freon (for example, chlorofluorocarbon, fluorocarbon, hydrochlorofluorocarbon, hydrofluorocarbon, halon and the like), hydrofluoric acid, fluorine simple substance, trifluoroacetic acid, carbon tetrafluoride, silicon tetrafluoride, phosphorus pentafluoride, phosphorus trifluoride, boron trifluoride, nitrogen trifluoride, and chlorine trifluoride.

As the gas or liquid of sulfur, a compound thereof or a chloride thereof, examples thereof include sulfurous acid, sulfuric acid, peroxomonosulfuric acid, thiosulfuric acid, dithionous acid, disulfuric acid, peroxodisulfuric acid, polythionic acid, hydrogen sulfide, and sulfur dioxide. Examples of the acid include hydrochloric acid, carbonic acid, boric acid, and lactic acid. Examples of the nitride include nitric acid, nitrogen monoxide, nitrogen dioxide, and nitrous oxide. These are not limited to gas or liquid.

Of these, hydrogen fluoride, freon, or hydrofluoric acid is preferred from the viewpoint of high reactivity with the glass sheet surface. Of these gases, two or more kinds thereof may be used as a mixture. Furthermore, since oxidation power is too strong in the float bath, it is preferable that fluorine simple substance is not used.

When a liquid is used, for example, the liquid may be supplied to the glass sheet surface by spray coating in the liquid form or the liquid may be vaporized and then supplied to the glass sheet surface. The liquid may be diluted with the other liquid or gas as necessary.

The liquid or gas capable of generating ion exchange reaction with an alkaline component in the glass may contain a liquid or gas other than the liquid or gas. The liquid or gas which may be contained is preferably a liquid or gas which does not react, at room temperature, with the liquid or gas capable of generating ion exchange reaction with an alkaline component in the glass.

Examples of the above-mentioned liquid or gas include N₂, air, H₂, O₂, Ne, Xe, CO₂, Ar, He, and Kr, but the liquid or gas is not limited thereto. Of these gases, two or more kinds thereof may be used as a mixture.

As a carrier gas for the gas capable of generating ion exchange reaction with an alkaline component in the glass, inert gas such as N₂ and argon is preferably used. The gas containing a molecule having a fluorine atom in the structure thereof may further contain SO₂. SO₂ is used when continuously producing a glass sheet by a float process or the like, and prevents the generation of a flaw in glass through a contact of a conveying roller with the glass sheet in a gradually cooling zone. Furthermore, a gas which is decomposed at a high temperature may be included.

Furthermore, the liquid or gas capable of generating ion exchange reaction with an alkaline component in the glass may contain water vapor or water. Water vapor can be extracted by bubbling heated water with an inert gas such as nitrogen, helium, argon, or carbon dioxide. In the case where a large amount of water vapor is required, it is also possible to adopt a method in which water is supplied to a vaporizer and is directly vaporized.

As a specific example of the method of forming the glass sheet having a sheet shape from molten glass in the present invention, a float process will be described in detail. In the float process, a glass sheet is produced using a glass producing apparatus including a melting furnace in which raw materials of the glass are melted, a float bath in which molten glass is floated on a molten metal (tin or the like) to form a glass ribbon, and a gradually cooling furnace in which the glass ribbon is gradually cooled.

At the time when glass is formed on a molten metal (tin) bath, the liquid or gas capable of generating ion exchange reaction with an alkaline component in the glass may be supplied to the glass sheet being conveyed on the molten metal bath from the side not in contact with the metal surface, thereby treating the glass sheet surface. In the gradually cooling zone subsequent to the molten metal (tin) bath, the glass sheet is conveyed by a roller.

Here, the gradually cooling zone includes not only the inside of the gradually cooling furnace but also a portion in the float bath where the glass sheet is conveyed from the molten metal (tin) bath into the gradually cooling furnace. In the gradually cooling zone, the liquid or gas may be supplied from the side not in contact with the molten metal (tin).

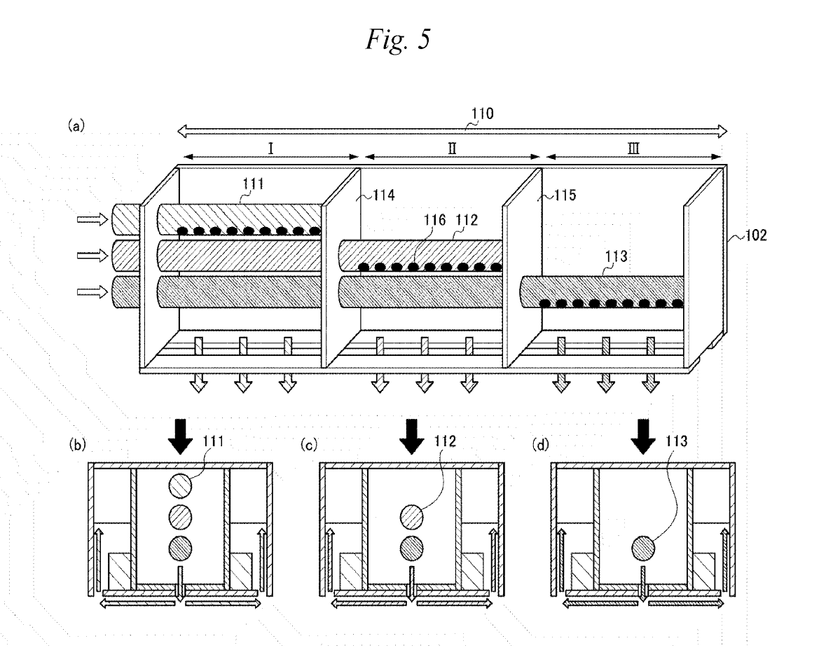

FIG. 4A shows a schematic explanatory view of a method of supplying a gas containing a molecule having a fluorine atom in the structure thereof to treat a glass surface, in the production of a glass sheet by a float process.

In the float bath in which molten glass is floated on a molten metal (tin or the like) to form a glass ribbon 101, the gas containing a molecule having a fluorine atom in the structure thereof is sprayed onto the glass ribbon 101 with a beam 102 inserted into the float bath. As shown in FIG. 4A, it is preferable that the gas is sprayed onto the glass ribbon 101 from the side on which the glass ribbon 101 is not in contact with the molten metal surface. An arrow Ya represents a direction in which the glass ribbon 101 flows in the float bath.

The position where the gas is sprayed onto the glass ribbon 101 with the beam 102 is preferably a position where the temperature of the glass ribbon 101 is 600° C. to 970° C., more preferably a position where the temperature thereof is 700° C. to 950° C., and still more preferably a position where the temperature thereof is 750° C. to 950° C., when a glass transition point of the glass ribbon 101 is 550° C. or higher. The position of the beam 102 may be on the upstream side or the downstream side of a radiation gate 103. It is preferable that the amount of the gas to be sprayed onto the glass ribbon 101 is 1×10⁻⁶ to 5×10⁻⁴ mol/1 cm² of the glass ribbon in terms of HF.

FIG. 4B shows an A-A cross-sectional view of FIG. 4A. The gas sprayed onto the glass ribbon 101 from the direction of Y1 with the beam 102 flows in from “IN” and flows out from the direction of “OUT”. That is, the gas moves in the direction of arrows Y4 and Y5 and is exposed to the glass ribbon 101. Furthermore, the gas which moves in the direction of the arrow Y4 flows out from the direction of an arrow Y2, and the gas which moves in the direction of the arrow Y5 flows out from the direction of an arrow Y3.

The warpage amount of the glass sheet after chemical strengthening may change depending on the position of the glass ribbon 101 in the width direction, and in such a case, it is preferable to adjust the amount of the gas. That is, it is preferable that the amount of the gas to be sprayed is increased at a position where the warpage amount is large and the amount of the gas to be sprayed is decreased at a position where the warpage amount is small.

In the case where the warpage amount of the glass sheet after chemical strengthening changes depending on the position of the glass ribbon 101, the structure of the beam 102 may be made such that the amount of the gas can be adjusted in the width direction of the glass ribbon 101, whereby the warpage amount is adjusted in the width direction of the glass ribbon 101.

As a specific example, (a) in FIG. 5 shows a cross-sectional view of the beam 102 in which the amount of the gas is adjusted while dividing it into three portions 1 to III in the width direction 110 of the glass ribbon 101. Gas systems 111 to 113 are divided with partition walls 114 and 115, and the gas flows out from respective gas blowing holes 116 and is sprayed onto the glass.

Arrows in (a) of FIG. 5 represent the flows of the gas. Arrows in (b) of FIG. 5 represent the flows of the gas in the gas system 111. Arrows in (c) of FIG. 5 represent the flows of the gas in the gas system 112. Arrows in (d) of FIG. 5 represent the flows of the gas in the gas system 113.

As a method of supplying the liquid or gas capable of generating ion exchange reaction with an alkaline component in the glass to the glass surface, for example, a method of using an injector, a method of using an introduction tube, and the like may be mentioned.

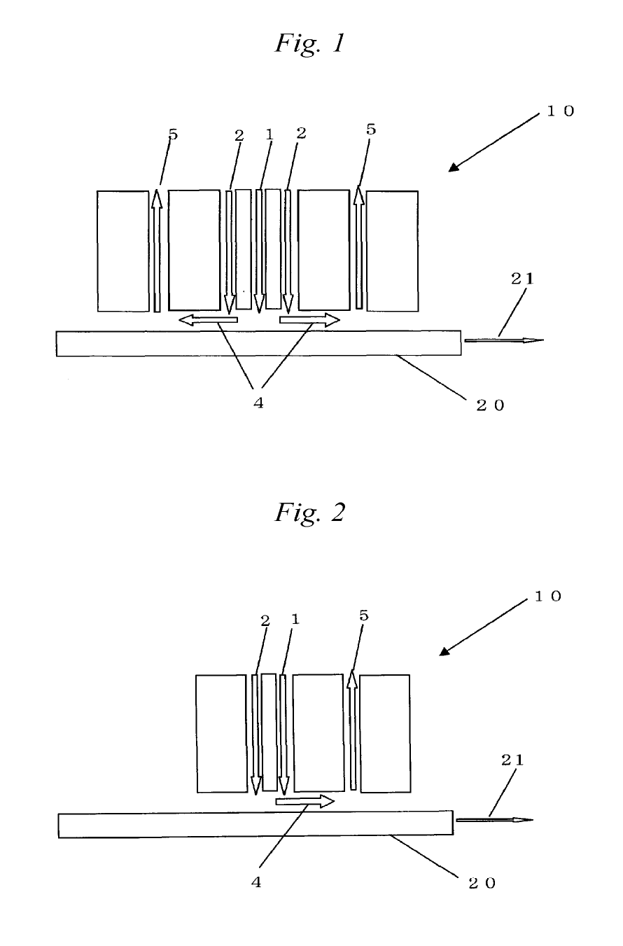

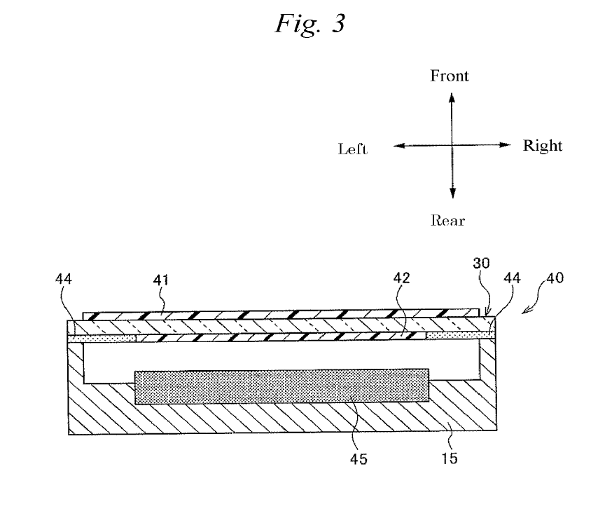

FIGS. 1 and 2 show schematic views of injectors employable in the present invention. FIG. 1 is a view schematically showing a double-flow type injector. FIG. 2 is a view schematically showing a single-flow type injector.

The gas or liquid containing a molecule having a fluorine atom in the structure thereof is injected toward a glass sheet 20 from a center slit 1 and an outer slit 2, flows through a channel 4 on the glass sheet 20, and is discharged from a discharge slit 5. The reference numeral 21 in FIGS. 1 and 2 is a direction in which the glass sheet 20 flows, and the direction thereof is parallel to the channel 4.

In the case where the “liquid or gas capable of generating ion exchange reaction with an alkaline component in the glass” to be supplied from the injector is a gas, it is preferable that the distance between a gas injection port of the injector and the glass sheet is 50 mm or less.

By controlling the distance to 50 mm or less, it is possible to suppress the diffusion of the gas into the air and to allow a sufficient amount of the gas to reach the glass sheet with respect to a desired amount of the gas. Conversely, in the case where the distance from the glass sheet is too short, at the time when the treatment of a glass sheet to be produced by a float process is performed on-line, there is a concern that the glass sheet and the injector come into contact with each other due to fluctuation of the glass ribbon.

In the case where the “liquid or gas capable of generating ion exchange reaction with an alkaline component in the glass” to be supplied from the injector is a liquid, the distance between the liquid injection port of the injector and the glass sheet is not particularly limited, and an arrangement may be made such that the glass sheet can be treated evenly.

As the injector, any type thereof, such as a double-flow type or a single-flow type, may be used, and two or more injectors may be arranged in series in the flow direction of the glass sheet to treat the glass sheet surface. As shown in FIG. 1, the double-flow type injector is an injector in which the flow of the gas from injection to discharge is split equally into a forward direction and a backward direction with respect to the moving direction of the glass sheet.

As shown in FIG. 2, the single-flow type injector is an injector in which the flow of the gas from injection to discharge is fixed to either a forward direction or a backward direction with respect to the moving direction of the glass sheet. When the single-flow type injector is used, it is preferable that the flow of the gas on the glass sheet and the moving direction of the glass sheet are identical in view of gas flow stability.

Also, it is preferable that a supply port of the liquid or gas capable of generating ion exchange reaction with an alkaline component in the glass and a discharge port of unreacted liquid or gas capable of generating ion exchange reaction with an alkaline component in the glass, a gas which is formed by a reaction with the glass sheet, and a gas which is formed by a reaction of two or more kinds of gases in the liquid or gas capable of generating ion exchange reaction with an alkaline component in the glass, are present on the same side of the surface of the glass sheet.

At the time when the liquid or gas capable of generating ion exchange reaction with an alkaline component in the glass is supplied to the surface of the glass sheet being conveyed to perform dealkalization treatment, for example, in the case where the glass sheet is flowing on a conveyor, the liquid or gas may be supplied from the side not in contact with the conveyor. Also, the liquid or gas may be supplied from the side in contact with the conveyor, by using a mesh material such as a mesh belt, with which a part of the glass sheet is not covered, as a conveyor belt.

By arranging two or more conveyors in series and disposing an injector between the adjacent conveyors, the liquid or gas may be supplied from the side in contact with the conveyor to treat the glass sheet surface. In the case where the glass sheet is flowing on a roller, the liquid or gas may be supplied from the side not in contact with the roller or may be supplied from a space between adjacent rollers on the side in contact with the roller.

The same kind or different kinds of liquid(s) or gas(es) may be supplied from both sides of the glass sheet. For example, the liquid or gas may be supplied from both of the side not in contact with the roller and the side in contact with the roller to perform dealkalization treatment of the glass sheet. For example, in the case where the liquid or gas is supplied from both sides in the gradually cooling zone, injectors may be arranged so as to face each other across the glass sheet with respect to the glass being continuously conveyed, and the liquid or gas may be supplied from both of the side not in contact with the roller and the side in contact with the roller.

The injector arranged on the side in contact with the roller and the injector arranged on the side not in contact with the roller may be arranged at different positions in the flow direction of the glass sheet. When arranging the injectors at different positions, any of the injector may be arranged on the upstream side or on the downstream side with respect to the flow direction of the glass sheet.

It is widely known that a transparent conductive film-attached glass sheet is produced on-line in combination of a glass production technique by a float process and a CVD technique. In this case, it is known that, with regard to the transparent conductive film and its base film, a gas is supplied from the surface not in contact with tin or from the surface not in contact with the roller to form the film on the glass sheet.

For example, in the production of the transparent conductive film-attached glass sheet by on-line CVD, an injector may be arranged on the surface in contact with the roller, and the liquid or gas capable of generating ion exchange reaction with an alkaline component in the glass may be supplied from the injector to the glass sheet to treat the glass sheet surface.

In the present invention, with regard to the surface temperature of the glass sheet at the time when the liquid or gas capable of generating ion exchange reaction with an alkaline component in the glass is supplied to the surface of the glass sheet being conveyed to treat the surface, in the case where the glass transition temperature of the glass sheet is taken as Tg, the surface temperature is preferably (Tg+50° C.) to (Tg+460° C.), more preferably (Tg+150° C.) to (Tg+460° C.), and further preferably (Tg+230° C.) to (Tg+460° C.).

Regardless of the above, the surface temperature of the glass sheet is preferably higher than 650° C. When the dealkalization treatment is performed at a surface temperature of the glass sheet of 650° C. or lower, a recess is likely to be generated.

The pressure of the glass sheet surface at the time when the liquid or gas capable of generating ion exchange reaction with an alkaline component in the glass is supplied to the glass sheet surface is preferably an atmosphere in the pressure range of (atmospheric pressure−100 Pa) to (atmospheric pressure+100 Pa), and more preferably, an atmosphere in the pressure range of (atmospheric pressure−50 Pa) to (atmospheric pressure+50 Pa).

With regard to the gas flow rate, a case where HF gas is used as the liquid or gas capable of generating ion exchange reaction with an alkaline component in the glass will be described as a representative example. At the time when the glass sheet is treated with HF gas, the higher the HF gas flow rate is, the greater the warpage improvement effect during chemical strengthening treatment is, so that the higher flow rate is preferable. When the total gas flow rate is equal, the higher the HF concentration is, the greater the warpage improvement effect during chemical strengthening treatment is.

In the case where both of the total gas flow rate and the HF gas flow rate are the same, the longer the time for treating the glass sheet is, the greater the warpage improvement effect during chemical strengthening treatment is. For example, in the case where the glass sheet is heated and the glass sheet surface is then treated using the liquid or gas capable of generating ion exchange reaction with an alkaline component in the glass, the warpage after chemical strengthening is improved as the conveying speed of the glass sheet decreases. Even in an equipment where the total gas flow rate or the HF flow rate cannot be well controlled, the warpage after chemical strengthening can be improved by appropriately controlling the conveying speed of the glass sheet.

### 3. Chemical Strengthening

Chemical strengthening is a treatment in which an alkali metal ion (typically, Li ion or Na ion) having a small ion radius in a glass surface is exchanged with an alkali metal ion (typically, K ion) having a larger ion radius through ion-exchanging at a temperature equal to or lower than the glass transition point to thereby form a compressive stress layer in the glass surface. The chemical strengthening treatment may be performed by a conventionally known method.

The chemically strengthened glass sheet of the present invention is a glass sheet in which the warpage after chemical strengthening is improved. The change amount of warpage (warpage change amount) of the glass sheet after chemical strengthening with respect to the glass sheet before chemical strengthening can be measured by a three-dimensional shape measurement instrument (for example, manufactured by Mitaka Kohki Co., Ltd.) or a surface roughness/outline shape measurement instrument (for example, manufactured by Tokyo Seimitsu Co., Ltd.).

In the present invention, the improvement of the warpage after chemical strengthening is evaluated by Δ(warpage amount) determined according to the following expression, in an experiment under the same conditions except that dealkalization treatment is performed by the liquid or gas capable of generating ion exchange reaction with an alkaline component in the glass.

Δ(warpage amount)=Warpage amount after chemical strengthening−Warpage amount before chemical strengthening

CS (surface compressive stress) and DOL (depth of compressive stress layer) of the glass sheet can be measured by a surface stress meter. The surface compressive stress of the chemically strengthened glass is preferably 600 MPa or more, and the depth of the compressive stress layer is preferably 15 μm or more. By controlling the surface compressive stress and the depth of the compressive stress layer of the chemically strengthened glass within the above ranges, excellent strength and scratch resistance can be obtained.

### 4. Flat Panel Display Device

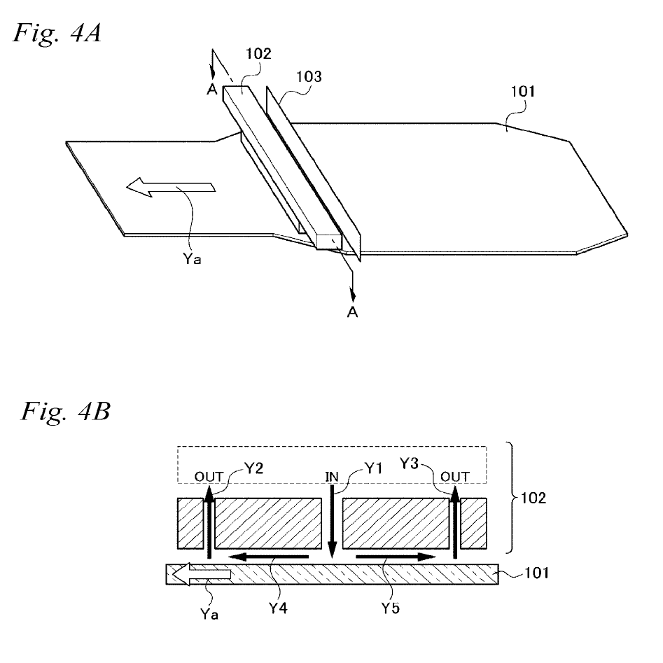

Hereinafter, an example in which the glass sheet of the present invention is chemically strengthened and the chemically strengthened glass is then used as a cover glass for a flat panel display device will be described. FIG. 3 is a cross-sectional view of the display device in which the cover glass is arranged. In the following description, the front, the rear, the left, and the right are based on the directions of arrows in the figure.

As shown in FIG. 3, a display device 40 includes a display panel 45 which is provided in a housing 15, and a cover glass 30 which is provided so as to cover the entire surface of the display panel 45 and to surround the front of the housing 15.

The cover glass 30 is primarily provided for the purpose of improving appearance and strength of the display device 40 or preventing damage caused by impact, and is formed of one sheet of sheet-shaped glass having an entire shape of a substantially planar shape. As shown in FIG. 3, the cover glass 30 may be arranged so as to be separated from the display side (front side) of the display panel 45 (to have an air layer) or may be attached to the display side of the display panel 45 through a light-transmissive adhesive film (not shown).

A functional film 41 is provided on the front surface of the cover glass 30 on which light from the display panel 45 is emitted, and a functional film 42 is provided on the rear surface, on which light from the display panel 45 is incident, at a position corresponding to the display panel 45. In FIG. 3, although the functional films 41 and 42 are provided on both surfaces, the present invention is not limited thereto, and the functional film may be provided on the front surface or the rear surface or may be omitted.

The functional films 41 and 42 have functions of, for example, antireflection of ambient light, impact damage prevention, electromagnetic ray shielding, near infrared ray shielding, color compensation, and/or scratch resistance improvement, and the thickness, the shape and the like thereof are appropriately selected depending on use applications. For example, the functional films 41 and 42 are formed by attaching a resin-made film to the cover glass 30. Alternatively, the functional films 41 and 42 may be formed by a thin film-forming method such as a vapor deposition method, a sputtering method and a CVD method.

A reference numeral 44 indicates a black layer and, for example, is a coating film formed by applying ink containing pigment particles onto the cover glass 30 and performing ultraviolet irradiation or heating and burning, followed by cooling. Thus, the display panel or the like is not viewed from the outside of the housing 15, and the aesthetics of the outward appearance is improved.

In the case where the glass sheet of the present invention is used as the cover glass of a display device as above, surface roughness (arithmetic average roughness) Ra is preferably 2.5 nm or less and further preferably 1.5 nm or less. As a result, the clearness of displayed images on the display device can be prevented from being impaired by the cover glass. The surface roughness Ra of the glass sheet can be measured as follows in accordance with JIS B0601 (2001). Using AFM (Atomic Force Microscope), for example, XE-HDM manufactured by Park Systems as a measuring apparatus, the roughness is measured at three places in a scan size of 1 μm×1 μm and an average value of the values at the three places is taken as the Ra value of the glass sheet.

### EXAMPLES

Hereinafter, Examples of the present invention will be specifically described. However, the present invention is not limited thereto.

### (Composition of Glass Sheet)

In the present Examples, glass sheets made of a glass material A or B having the following composition were used.

(Glass material A) Glass containing, in terms of mol %, 64.3% of SiO₂, 8.0% of Al₂O₃, 12.5% of Na₂O, 4.0% of K₂O, 10.5% of MgO, 0.1% of CaO, 0.1% of SrO, 0.1% of BaO, and 0.5% of ZrO₂ (glass transition temperature: 604° C.).
(Glass material B) Glass containing, in terms of mol %, 68.0% of SiO₂, 10.0% of Al₂O₃, 14.0% of Na₂O, and 8.0% of MgO (glass transition temperature: 662° C.).

### (Measurement of Warpage Amount)

After a warpage amount was measured by SURFCOM surface roughness/outline shape measurement instrument (manufactured by Tokyo Seimitsu Co., Ltd.) before chemical strengthening, each glass was chemically strengthened, the warpage amount after chemical strengthening was measured in the same manner, and Δ(warpage amount) expressed by the following expression was calculated. Δ(warpage amount)=Warpage amount after chemical strengthening−Warpage amount before chemical strengthening

### (XRF Method)

The analytical conditions in the XRF (X-ray fluorescence spectrometry) method were as mentioned below. The quantitative analysis was carried out according to a calibration curve method using Na₂O standard samples.

Measurement apparatus: ZSX100 manufactured by Rigaku Corporation

Output: Rh 50 kV-72 mA

Filter: OUT

Attenuator: 1/1

Slit: Std.

Dispersive crystal: RX25

Detector: PC

Peak angle (2θ/deg.): 47.05

Peak measurement time (second): 40

B. G. 1 (2θ/deg.): 43.00

B. G. 1 measurement time (second): 20

B. G. 2 (2θ/deg.): 50.00

B. G. 2 measurement time (second): 20

PHA: 110-450

### (CS and DOL)

CS and DOL were measured using a surface stress meter (FSM-6000LE) manufactured by Orihara Industrial Co., Ltd.

### (HF Total Contact Amount)

An HF total contact amount (mol/cm²) was determined according to the following expression. The treating time in the expression is a time for which HF gas is in contact with the surface of a glass ribbon.

[HF Total contact amount (mol/cm²)]=[HF gas concentration (% by volume)]/100×[gas flow rate (mol/s/cm²)]×[Treating time (s)] (b)

### Example 1

In a float bath in which a glass ribbon made of the glass material A flowed, dealkalization treatment was conducted using HF gas as a liquid or gas capable of generating ion exchange reaction with an alkaline component in the glass.

The obtained glass having a thickness of 0.7 mm was cut into three sheets each 100 mm square, warpage of two diagonal lines of a portion corresponding to a portion 90 mm square of the substrate was measured, and an average value thereof was taken as a warpage amount before strengthening. Also, there were measured a surface Na₂O amount in one surface of the glass measured by the XRF analysis; the surface Na₂O amount in the other surface thereof; and a difference in terms of % by mass therebetween (ΔNa₂O amount). Thereafter, the glass sheet was immersed in KNO₃ molten salt heated to 450° C. for 2 hours and thus chemical strengthening was performed. Next, warpage of two diagonal lines of a portion corresponding to a portion 90 mm square of the substrate was measured and an average value thereof was taken as a warpage amount after the strengthening.

The results are shown in Table 1. Incidentally, Comparative Example 1-1 is a reference where the dealkalization treatment was not performed. In Examples 1-1 to 1-16, since only one surface of the glass ribbon is subjected to dealkalization treatment, the dealkalization treatment is not performed on the non-treated surface and it is considered that the average Na₂O amount at 0 to 1 μm of the untreated surface is not changed by the dealkalization treatment. Accordingly, with regard to Examples 1-1 to 1-16 where the average Na₂O amount at 0 to 1 μm of the untreated surface was not measured, Δ(Na₂O amount) was calculated using the average Na₂O amount at 0 to 1 μm of the bottom surface in Comparative Example 1-1 as the average Na₂O amount at 0 to 1 μm of the untreated surface.

Furthermore, when surface observation was conducted using SEM at a magnification of 50,000 for the dealkalization-treated surfaces of the glass sheets of respective Examples and Comparative Example, no recess generation was observed for Examples 1-1 to 1-16 and Comparative Example 1-1.

TABLE 1

| | | | | | | | | | | Results of XRF spectrometry | | |
|---|---|---|---|---|---|---|---|---|---|---|---|---|
| | HF treatment | | | | | | Warpage [μm] | | | Average Na₂O | Average Na₂O | |
| | Treating | | HF | HF total | Surface | | Before | After | | amount at 0-1 | amount at 0-1 | Δ (Na₂O |
| | temper- | | contact | contact | stress | | chemical | chemical | | μm of treated | μm of untreated | amount) |
| | ature | L/S | time | amount | CS | DOL | strength- | strength- | Δ (warpage | surface | surface | [% by |
| | [° C.] | [m/h] | [s] | [mol/cm²] | (MPa) | (μm) | ening | ening | amount) | [% by mass] | [% by mass] | mass] |
| Example 1-1 | 911 | 680 | 3.2 | 1.28E−04 | 745.3 | 42.9 | −9.7 | −27.9 | −18.2 | 12.14 | — | 0.46 |
| Example 1-2 | 911 | 680 | 3.2 | 1.70E−04 | 761.3 | 42.6 | −8.2 | −43.5 | −35.3 | 12.10 | — | 0.50 |
| Example 1-3 | 911 | 680 | 3.2 | 2.13E−04 | 760.0 | 42.7 | −10.2 | −59.5 | −49.3 | 12.13 | — | 0.47 |
| Example 1-4 | 911 | 680 | 3.2 | 3.83E−04 | 748.2 | 43.0 | −16.4 | −141.3 | −124.9 | 12.11 | — | 0.49 |
| Example 1-5 | 911 | 680 | 3.2 | 3.40E−04 | 757.1 | 42.7 | −18.2 | −123.3 | −105.1 | 12.06 | — | 0.53 |
| Example 1-6 | 911 | 680 | 3.2 | 2.98E−04 | 752.4 | 43.0 | −12.1 | −96.4 | −84.4 | 12.08 | — | 0.52 |
| Example 1-7 | 911 | 680 | 3.2 | 2.55E−04 | 726.5 | 43.3 | −14.2 | −92.2 | −78.1 | 12.07 | — | 0.53 |
| Example 1-8 | 911 | 680 | 3.2 | 8.51E−05 | 731.3 | 43.3 | −9.5 | −14.3 | −4.8 | 12.13 | — | 0.47 |
| Example 1-9 | 911 | 680 | 3.2 | 4.25E−05 | 737.1 | 42.9 | −7.8 | 17.4 | 25.2 | 12.14 | — | 0.45 |
| Example 1-10 | 911 | 680 | 3.2 | 7.66E−05 | 739.3 | 43.0 | −7.7 | −15.4 | −7.7 | 12.04 | — | 0.56 |
| Example 1-11 | 911 | 680 | 3.2 | 1.02E−04 | 765.4 | 42.5 | −10.1 | −15.4 | −5.3 | 12.04 | — | 0.55 |
| Example 1-12 | 911 | 680 | 3.2 | 1.28E−04 | 743.5 | 43.1 | −7.2 | −25.9 | −18.7 | 12.04 | — | 0.56 |
| Example 1-13 | 911 | 680 | 3.2 | 1.53E−04 | 736.3 | 43.3 | −11.0 | −24.6 | −13.6 | 12.02 | — | 0.58 |
| Example 1-14 | 911 | 680 | 3.2 | 7.66E−05 | 736.8 | 43.2 | −8.3 | −26.8 | −18.5 | 12.02 | — | 0.57 |
| Example 1-15 | 911 | 680 | 3.2 | 1.02E−04 | 742.2 | 43.3 | −11.5 | −28.4 | −17.0 | 12.03 | — | 0.57 |
| Example 1-16 | 911 | 680 | 3.2 | 1.53E−04 | 743.2 | 43.0 | −7.4 | −18.5 | −11.1 | 12.04 | — | 0.55 |
| Comparative | 911 | 680 | 3.2 | 0.00E+00 | 750.1 | 42.7 | 6.6 | 123.7 | 117.2 | 12.34 | 12.60 | 0.25 |
| Example 1-1 | | | | | | | | | | | | |

As shown in Table 1, in the glass sheet of each Example where Δ(Na₂O amount) determined from the Na₂O amounts of both surfaces was 0.38% by mass or more, it was found that Δ(warpage amount) decreased and the warpage after chemical strengthening was improved, as compared with the glass sheet of Comparative Example.

### Example 2

HF treatment was conducted in the same manner as in Example 1 in a float bath in which a glass ribbon made of the glass material B (Examples 2-1 to 2-3 and

Comparative Examples 2-1 to 2-4) flowed, except that the glass material A was changed to the glass material B and the time for chemical strengthening was 1.5 hours. The I-IF treatment was conducted at a position where the temperature of the glass ribbon was 910° C. or higher. The resulting glass sheet was subjected to measurements by the same procedures as in Example 1 and the warpage amounts, the Na₂O amount, and the like were calculated.

The results are shown in Table 2. Incidentally, Comparative Examples 2-1 to 2-4 are references where the HF treatment was not performed. Δ(Na₂O amount) was calculated using the average Na₂O amount at 0 to 1 μm of the bottom surface in Comparative Example 2-1 as the average Na₂O amount at 0 to 1 μm of the untreated surface.

Furthermore, when surface observation was conducted using SEM at a magnification of 50,000 for the dealkalization-treated surfaces of the glass sheets of respective Examples and Comparative Examples, no recess generation was observed for Examples 2-1 to 2-3 and Comparative Examples 2-1 to 2-4.

TABLE 2

| | | | | | | | Results of XRF spectrometry | | |
|---|---|---|---|---|---|---|---|---|---|
| | HF treatment | | | Warpage [μm] | | | Average Na₂O | Average Na₂O | |
| | HF total | Surface | | Before | After | | amount at 0-1 | amount at 0-1 | Δ (Na₂O |
| | contact | stress | | chemical | chemical | | μm of treated | μm of untreated | amount) |
| | amount | CS | DOL | strength- | strength- | Δ (warpage | surface | surface | [% by |
| | [mol/cm²] | (MPa) | (μm) | ening | ening | amount) | [% by mass] | [% by mass] | mass] |
| Example 2-1 | 8.53E−06 | 945.0 | 26.6 | −15.0 | −17.0 | −2.0 | 12.58 | — | 0.62 |
| Example 2-2 | 6.61E−06 | 919.0 | 27.0 | −2.2 | 10.0 | 12.2 | 12.74 | — | 0.46 |
| Example 2-3 | 5.79E−06 | 941.0 | 27.0 | 4.8 | −16.6 | −21.4 | 12.69 | — | 0.51 |
| Comparative | 0.00E+00 | 925.0 | 26.9 | −10.8 | 50.6 | 61.4 | 13.17 | 13.20 | 0.03 |
| Example 2-1 | | | | | | | | | |
| Comparative | 0.00E+00 | 931.0 | 26.9 | −9.5 | 44.7 | 54.2 | 12.98 | — | 0.22 |
| Example 2-2 | | | | | | | | | |
| Comparative | 0.00E+00 | 931.0 | 26.8 | −11.4 | 44.2 | 55.6 | 12.95 | — | 0.25 |
| Example 2-3 | | | | | | | | | |
| Comparative | 0.00E+00 | 927.0 | 26.9 | −12.2 | 35.5 | 47.7 | 12.89 | — | 0.31 |
| Example 2-4 | | | | | | | | | |

As shown in Table 2, in the glass sheet of each Example where Δ(Na₂O amount) determined from the Na₂O amounts of both surfaces was 0.38% by mass or more, it was found that Δ(warpage amount) decreased and the warpage after chemical strengthening was improved, as compared with the glass sheets of Comparative Examples.

While the invention has been described in detail with reference to specific embodiments thereof, it will be apparent to one skilled in the art that various changes and modifications can be made therein without departing from the spirit and scope of the invention. The present application is based on Japanese Patent Application No. 2013-198469 filed on Sep. 25, 2013 and the contents thereof are incorporated herein by reference.

### DESCRIPTION OF REFERENCE NUMERALS AND SIGNS

1: Center slit
2: Outer slit
4: Channel
5: Discharge slit
15: Housing
20: Glass sheet
30: Cover glass
40: Display device
41, 42: Functional film
45: Display panel
101: Glass ribbon
102: Beam
103: Radiation gate
110: Width direction of glass ribbon
111, 112, 113: Gas system
114, 115: Partition wall
116: Gas blowing hole

1. A glass sheet containing 4 mol % or more of Al₂O₃, wherein a surface Na₂O amount in one surface thereof is lower than the surface Na₂O amount in the other surface by 0.38% by mass to 1.2% by mass.

2. The glass sheet according to claim 1, wherein the surface Na₂O amount in one surface thereof is lower than the surface Na₂O amount in the other surface by 0.4% by mass to 0.7% by mass.

3. The glass sheet according to claim 1, which is produced by a float process, wherein the surface having a lower surface Na₂O amount is a surface which has not been in contact with a molten metal in a float bath.

4. The glass sheet according to claim 1, which has a thickness of 1.5 mm or less.

5. The glass sheet according to claim 1, which has a thickness of 0.8 mm or less.

6. A glass sheet obtained by chemically strengthening the glass sheet according to claim 1.

7. A glass sheet containing no CaO or containing 6 mol % or less of CaO, wherein a surface Na₂O amount in one surface thereof is lower than the surface Na₂O amount in the other surface by 0.38% by mass to 1.2% by mass.

8. The glass sheet according to claim 7, wherein the surface Na₂O amount in one surface thereof is lower than the surface Na₂O amount in the other surface by 0.4% by mass to 0.7% by mass.

9. The glass sheet according to claim 7, which is produced by a float process, wherein the surface having a lower surface Na₂O amount is a surface which has not been in contact with a molten metal in a float bath.

10. The glass sheet according to claim 7, which has a thickness of 1.5 mm or less.

11. The glass sheet according to claim 7, which has a thickness of 0.8 mm or less.

12. A glass sheet obtained by chemically strengthening the glass sheet according to claim 7.

13. A glass sheet containing 3 mol % or more of K₂O, wherein a surface Na₂O amount in one surface thereof is lower than the surface Na₂O amount in the other surface by 0.38% by mass to 1.2% by mass.

14. The glass sheet according to claim 13, wherein the surface Na₂O amount in one surface thereof is lower than the surface Na₂O amount in the other surface by 0.4% by mass to 0.7% by mass.

15. The glass sheet according to claim 13, which is produced by a float process, wherein the surface having a lower surface Na₂O amount is a surface which has not been in contact with a molten metal in a float bath.

16. The glass sheet according to claim 13, which has a thickness of 1.5 mm or less.

17. The glass sheet according to claim 13, which has a thickness of 0.8 mm or less.

18. A glass sheet obtained by chemically strengthening the glass sheet according to claim 13.

19. A chemically strengthened glass sheet, wherein a surface Na₂O amount in one surface thereof is lower than the surface Na₂O amount in the other surface by 0.38% by mass to 1.2% by mass.

20. The chemically strengthened glass sheet according to claim 19, which has a thickness of 1.5 mm or less.

21. The chemically strengthened glass sheet according to claim 19, which has a thickness of 0.8 mm or less.

22. A flat panel display device comprising a cover glass, wherein the cover glass is the chemically strengthened glass sheet according to claim 19.
